(19) United States
(12) Patent Application Publication
(10) Pub. No.: US 2019/0370699 A1
(43) Pub. Date: Dec. 5, 2019

(54) METHOD TO USE TELEMATICS TO AUTHENTICATE A MOBILE DEVICE TO A VEHICLE FOR VEHICLE ACCESS AND OPERATION

(71) Applicant: GM Global Technology Operations LLC, Detroit, MI (US)

(72) Inventors: Caroline Chaplow, Burketon (CA); Shaun S. Marshall, Port Perry (CA); Thomas E. Utter, Royal Oak, MI (US)

(21) Appl. No.: 15/996,856

(22) Filed: Jun. 4, 2018

(51) Int. Cl. G06Q 10/02; B60R 25/24; H04L 9/08

(52) U.S. Cl. CPC G06Q 10/02; H04L 9/088; B60R 25/241

(57) ABSTRACT

A method for authenticating a vehicle reservation by a user using a telematics authentication system includes opening a telematics authentication system application in a mobile device. A reservation for a vehicle is created via the telematics authentication system application including selecting the vehicle from multiple identified vehicles and identifying a reservation start date. The reservation is wirelessly submitted to a remotely located server. The server creates and downloads a valid certificate for the reservation to the vehicle. The vehicle sends a secret key to the mobile device after which the telematics authentication system application is closed. On the reservation start date the mobile device and the vehicle are positioned within a predefined wireless connection range and the telematics authentication system application is reopened in the mobile device to permit wireless authentication of the secret key for operation of the vehicle.

The present disclosure relates to systems and methods for authenticating communication links between mobile devices and automobile vehicles.

The reserved use of an automobile vehicle from a fleet of vehicles can be presently accomplished from a mobile device such as a smart phone using an authentication process including Bluetooth® low energy (BLE). BLE data transfer uses short-wavelength radio waves. The current BLE authentication process involves a user downloading an application to the mobile device. Using the application, the user forwards a reservation request to a base system, which in response forwards encrypted authentication data concerning the vehicle, the reservation data, and the vehicle identification data back to the mobile device. At the time and date of the reservation, the user approaches the vehicle and the mobile device communicates the reservation data to the vehicle, which permits the user to enter and start the vehicle.

The transfer of a large volume of security and identification data from the mobile device can require approximately 12 to 15 seconds. BLE data transfer is line-of-sight distance limited, and normally requires the mobile device be within a proximity range of approximately 10 meters up to approximately 300 meters of the vehicle. Data transfer may also be impacted by local conditions such as line-of-sight building interference and weather, therefore under worst case conditions the user may have to wait for the entire 15 second period for authentication to finish. This method therefore introduces latency and cannot be initiated until the mobile device is within BLE range of the vehicle.

Thus, while current methods to reserve a vehicle from a fleet of vehicles achieve their intended purpose, there is a need for a new and improved system and method for reserving a vehicle from a fleet of vehicles.

### SUMMARY

According to several aspects, a method for authenticating a vehicle reservation by a user using a telematics authentication system includes: wirelessly submitting a vehicle reservation from a mobile device to a remotely located server, the server creating and forwarding a valid certificate to a vehicle and returning a secret key from the vehicle to a mobile device of a user; positioning the mobile device and the vehicle within a predefined wireless connection range to permit confirmation of the secret key with the vehicle; and opening a telematics authentication system application in the mobile device, the mobile device using the telematics authentication system application using the secret key to authorize operation of the vehicle.

In another aspect of the present disclosure, the method includes at a predetermined time before the start of the vehicle reservation, in a data transfer step the server forwarding an encrypted reservation certificate to the vehicle.

In another aspect of the present disclosure, the method includes saving the encrypted reservation certificate in a vehicle telematics module of the vehicle, the encrypted reservation certificate including an intermediate certificate and a user token.

In another aspect of the present disclosure, the method includes in a confirmation step the vehicle wirelessly transmits the secret key as an encrypted secret key defining in part a reproduction of the intermediate certificate or the user token to the server.

In another aspect of the present disclosure, the method includes upon receipt of the encrypted secret key, the mobile device decrypts the encrypted secret key and stores a decrypted secret key.

In another aspect of the present disclosure, the method includes verifying the authenticity of the decrypted secret key in a vehicle computer.

In another aspect of the present disclosure, the method includes: forwarding an intermediate certificate serial number from the vehicle telematics module to a computer in the vehicle; identifying using the computer if the intermediate certificate serial number represents a new certificate serial number, and returning a data request to the vehicle telematics module; forwarding the intermediate certificate from the vehicle telematics module to the computer; and the computer authenticating and storing the intermediate certificate.

In another aspect of the present disclosure, the method includes: the computer authenticating and storing a user certificate and generating the secret key as an encrypted secret key; and the computer forwarding the encrypted secret key to the vehicle telematics module.

In another aspect of the present disclosure, the positioning step further includes moving the mobile device toward the vehicle until the predefined wireless connection range is achieved.

In another aspect of the present disclosure, the positioning step further includes autonomously moving the vehicle toward the mobile device until the predefined wireless connection range is achieved.

According to several aspects, a method for authenticating a vehicle reservation by a user using a telematics authentication system includes: opening a telematics authentication system application in a mobile device; creating a reservation for a vehicle via the telematics authentication system application; wirelessly submitting the reservation to a remotely located server and closing the telematics authentication system application; the server creating and forwarding a valid certificate to the vehicle and sending a secret key to the mobile device; and reopening the telematics authentication system application in the mobile device to submit the secret key to the vehicle to authorize operation of the vehicle.

In another aspect of the present disclosure, the creating step includes selecting the vehicle and identifying a reservation start date.

In another aspect of the present disclosure, the reopening step is performed at a predetermined time on the reservation start date ahead of a user accessing the vehicle.

In another aspect of the present disclosure, the method includes positioning the mobile device and the vehicle within a predefined wireless connection range to permit submission of the secret key to the vehicle.

In another aspect of the present disclosure, the positioning step further includes one of: moving the mobile device toward the vehicle until the predefined wireless connection range is achieved; or if the vehicle is an autonomously operated vehicle autonomously moving the vehicle toward the mobile device until the predefined wireless connection range is achieved.

In another aspect of the present disclosure, the method includes uploading personalized data by the user at the time of generating the reservation including radio preferences, lighting preferences, seat positions, mirror positions, and climate control settings.

In another aspect of the present disclosure, the method includes uploading personalized data saved in the server to the vehicle at the time of generating the reservation including radio preferences, lighting preferences, seat positions, mirror positions, and climate control settings.

According to several aspects, a method for authenticating a vehicle reservation by a user using a telematics authentication system includes: opening a telematics authentication system application in a mobile device. A reservation for a vehicle is created via the telematics authentication system application including selecting the vehicle from multiple identified vehicles and identifying a reservation start date. The reservation is wirelessly submitted to a remotely located server. The server creates and downloads a valid certificate for the reservation to the vehicle. The vehicle sends a secret key to the mobile device after which the telematics authentication system application is closed. On the reservation start date the mobile device and the vehicle are positioned within a predefined wireless connection range and the telematics authentication system application is reopened in the mobile device to permit wireless authentication of the secret key for operation of the vehicle.

In another aspect of the present disclosure, the method includes operating a computer in the vehicle to authenticate the secret key.

In another aspect of the present disclosure, the method includes following authentication of the secret key the computer sending a response verification successful signal to the mobile device to authorize operation of the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a flow diagram of reservation and authentication steps for a telematics authentication system according to an exemplary embodiment;

FIG. 2 is a flow diagram of authentication procedural steps for the system of FIG. 1; and

FIG. 3 is a top plan view of a vehicle equipped for operation using the telematics authentication system of FIG. 1.

### DETAILED DESCRIPTION

The following description is merely exemplary in nature and is not intended to limit the present disclosure, application, or uses.

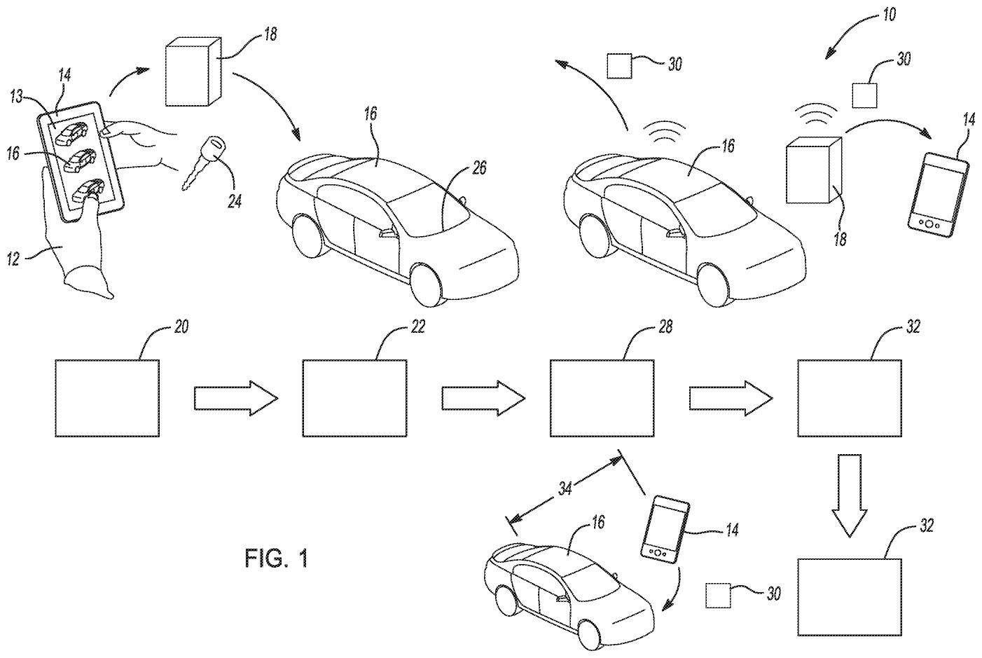

Referring to FIG. 1, a telematics authentication system 10 provides for a user 12 to open an application 13 on a mobile device 14 such as a smart phone which allows the user 12 to select a vehicle 16 from a variety of available vehicles identified in the application 13. The selected vehicle 16 together with reservation information including but not limited to start date of use, expected duration of use, return date and time, and the like are wirelessly transmitted to a remote server 18 in a reservation step 20. The server 18 confirms availability of the requested vehicle 16 for the reservation time frame and enters and saves the reservation data.

At a predetermined time before the start of the reservation, in a data transfer step 22 the server 18 forwards an encrypted reservation certificate 24 including an intermediate certificate and a user token to the vehicle 16 which is saved in a memory of a vehicle telematics module 26 of the vehicle 16. To confirm receipt of the reservation certificate 24, in a confirmation step 28 the vehicle 16 wirelessly transmits an encrypted secret key 30 defining in part a reproduction of the intermediate certificate or the user token back to the server 18 or to the mobile device 14.

Upon receipt of the encrypted secret key 30, the server 18 in a forwarding step 32 forwards the encrypted secret key 30 to the mobile device 14 which decrypts and stores the encrypted secret key 30 as a decrypted secret key 30. The mobile device 14 is thereafter ready for secure communication with the vehicle 16. The user 12 at this time closes the application 13 on the mobile device 14.

At a predetermined time, for example approximately 7 to 15 minutes prior to start of vehicle operation, the user 12 reopens the application 13 in the mobile device 14, and brings the mobile device 14 into a predefined wireless connection range 34 of the vehicle 16, or the vehicle 16 moves within the predefined wireless connection range 34 with respect to the mobile device 14 of the user 12. As previously noted, the wireless connection range 34 varies between approximately 10 meters up to approximately 300 meters.

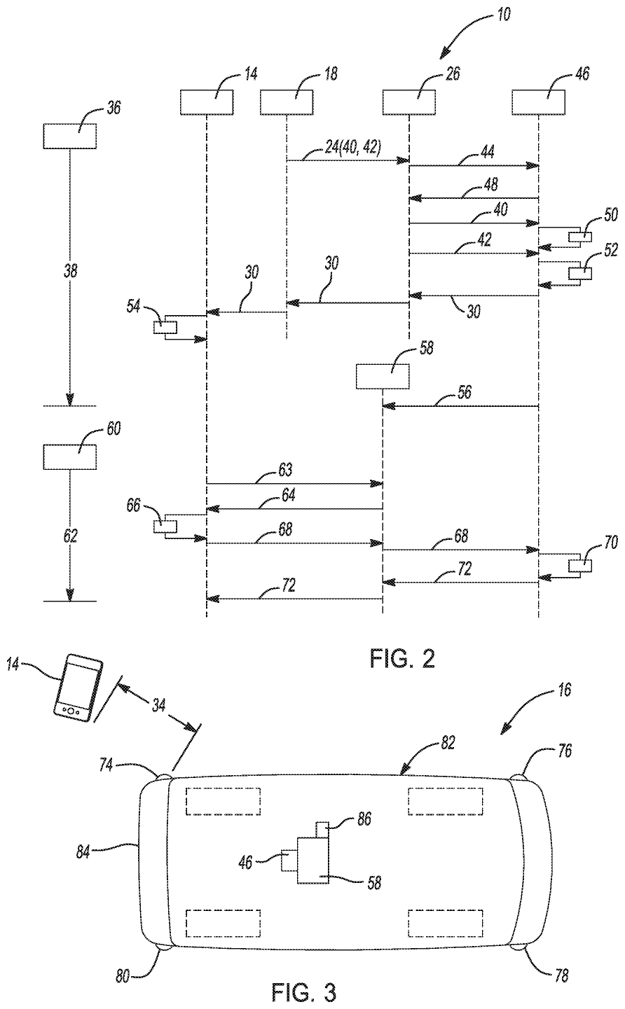

The decrypted secret key 30 is exchanged between the vehicle 16 and the mobile device 14. The vehicle 16 verifies the authenticity of the reservation details as described in greater in reference to FIG. 2 herein using the decrypted secret key 30, thereby allowing the user 12 to enter and operate the vehicle 16 for the predetermined time period of the reservation. The amount of data exchanged between the vehicle 16 and the mobile device 14 using a protocol such as BLE protocol over the limited or predefined wireless connection range 34 at the time when the user desires access to the vehicle 16 is minimized because a bulk of the reservation data had previously been exchanged directly between the server 18 and the vehicle 16 without requiring the presence of the user 12. The time required for encrypted secret key 30 authentication, and therefore a maximum anticipated time for the user 12 to gain access to the vehicle 16 is approximately 4 seconds or less. Because the user 12 may be moving toward the vehicle 16, or if the vehicle 16 is an autonomous vehicle moving toward the user 12, the user 12 is not expected to be cognizant of a delay in accessing the vehicle 16 during the approximate 4 second authentication process.

Referring to FIG. 2 and again to FIG. 1, multiple communication operations are delineated which the telematics authentication system 10 performs in a first stage 36 during a first time period 38 after the user 12 initiates the request for a reservation, but prior to the start of vehicle use. As previously noted the server 18 forwards the encrypted reservation certificate 24 including an intermediate certificate 40 and a user token 42 to the vehicle telematics module 26. The vehicle telematics module 26 forwards an intermediate certificate serial number 44 to a computer 46 in the vehicle 16. The computer 46 identifies if the intermediate certificate serial number 44 represents a new certificate serial number, and returns a data request 48 to the vehicle telematics module 26. In response to the data request 48, the vehicle telematics module 26 either forwards the intermediate certificate 40 if new, or forwards the user token 42 to the computer 46. If the intermediate certificate 40 is received, the computer 46 in an authentication step 50 authenticates and stores the intermediate certificate 40.

Using either the authenticated intermediate certificate 40 or the user token 42, the computer 46 in a step 52 authenticates and stores a user certificate and generates the encrypted secret key 30 discussed above in reference to FIG. 2, and forwards the encrypted secret key 30 to the vehicle telematics module 26. The encrypted secret key 30 is then forwarded from the vehicle telematics module 26 of the vehicle 16 to the server 18, which forwards the encrypted secret key 30 to the mobile device 14. In a step 54 and as previously noted the encrypted secret key 30 is decrypted and stored by the mobile device 14 for subsequent use. The user 12 at this time closes the application 13 on the mobile device 14.

Once the encrypted secret key 30 is generated by the computer 46, a valid certificate 56 indicating the reservation is complete and validated is generated by the computer 46 which is forwarded and saved in a vehicle module 58. According to several aspects, the vehicle module 58 defines a Bluetooth® Low Energy module or a similar low energy, limited range wireless transmission system. Although the first time period 38 required for completion of all of the operations of the first stage 36 may range between approximately 12 seconds up to approximately 15 seconds, any of the operations of the first stage 36 can be delayed or rescheduled to suit the number or overlapping requirements of the reservations received by the server 18. Delays occurring during the first stage 36 which may occur for example due to vehicle return delays, reservation cancellations, rescheduling, or vehicle maintenance are not apparent to the user 12.

Following performance of the multiple communication operations in the first stage 36, the following events occur in a second stage 60 during a second time period 62 when the mobile device 14 and the vehicle 16 are brought into the wireless connection range 34 to permit completion of the reservation. According to several aspects the second time period 62 is approximately 4 seconds or less.

When the user 12 reopens the reservation application 13 in the mobile device 14, and after the mobile device 14 and the vehicle 16 are within the wireless connection range 34, the mobile device 14 wirelessly transmits an authentication status query 63 which is received by the vehicle module 58. The vehicle module 58 confirms the valid certificate 56 is present and returns a random challenge 64 to the mobile device 14. Upon receipt of the random challenge 64, the mobile device 14 in a step 66 retrieves the decrypted secret key 30 from memory and calculates a response. The calculated response is forwarded as a signal 68 verifying the secret key 30 was received to the vehicle module 58. The vehicle module 58 in turn forwards the signal 68 to the computer 46. If the computer 46 in an authentication step 70 authenticates the response received with the signal 68 the computer 46 sends a verification successful response signal 72 to the vehicle module 58. The vehicle module 58 forwards the verification successful response signal 72 to the mobile device 14 to complete the authentication process, thereby allowing the user 12 to access the vehicle 16.

Referring to FIG. 3 and again to FIGS. 1 through 2, according to several aspects the vehicle 16 is equipped with multiple sensors that identify if the mobile device 14 and the vehicle 16 are together within the predefined wireless connection range 34. These may include first, second, third and fourth sensors 74, 76, 78, 80 which are spaced about a body 82 of the vehicle 16, or to one or more bumpers 84. An additional interior sensor 86 is positioned within the vehicle 16, for example connected to or positioned within the vehicle module 58. Although a response from any one of the first, second, third or fourth sensors 74, 76, 78, 80 indicating the mobile device 14 and the vehicle 16 are together within the predefined wireless connection range 34 is sufficient to permit the user entrance into the vehicle 16, a signal from the interior sensor 86 identifying the mobile device 14 is positioned within the vehicle 16 is required before the vehicle can be operated by the user 12. The interior sensor 86 can therefore have a reduced sensitivity range compared to the first, second, third and fourth sensors 74, 76, 78, 80.

As previously noted the telematics authentication system 10 is operable to authenticate the secret key 30 when the mobile device 14 and the vehicle 16 are together within the predefined wireless connection range 34. This occurs when the user 12 and therefore the mobile device 14 approaches the vehicle 16, or if the vehicle 16 is an autonomously operated vehicle which approaches the user 12 and the mobile device 14.

The telematics authentication system 10 using the server 18 notifies the vehicle 16 of the reservation details for the user 12 at the time the user 12 makes the reservation, and before the user 12 approaches within the predefined wireless connection range 34 of the vehicle 16. Through the use of the telematics authentication system 10 a resultant authentication latency is reduced from a range of approximately 12 to 15 seconds for a system requiring all data to transfer from the user's mobile device to the vehicle to approximately 4 seconds or less.

The telematics authentication system 10 also permits personalized data of the user 12 to be uploaded by the user or by the system at the time of generating the reservation, therefore features and functions desired by the user 12 are ready when the user 12 enters the vehicle 16. Such features and functions include but are not limited to radio preferences, lighting preferences, seat positions, mirror positions, climate control settings, and the like. This information can be uploaded by the user 12 at the time of making the reservation, or, if the user 12 has made a previous reservation using the telematics authentication system 10 this information can be retrieved from data stored in or accessed by the server 18, or stored in the computer 46.

The basic steps for obtaining a reservation are as follows. At specified time before the start of the reservation, user credentials are passed from a user's mobile device to a server and from the server to the vehicle using telematics. The vehicle performs device authorization and transmits a secret key to the server which then transmits the secret key to the mobile device. According to several aspects, the mobile device signals a status of the advanced reservation process and a confirmation signal or alert is issued to the user by the mobile device signifying receipt of the secret key defining a reservation complete signal. At a later date or time the mobile device exchanges encrypted communication with the vehicle to allow user access to the vehicle. In the event that there is no packet data connection to the vehicle, a secondary method of passing credentials through the mobile device to the vehicle using BLE is used. Prior to the first use of the mobile device with a vehicle, the authentication credentials are downloaded from the server to the vehicle using a telematics connection.

The location of the vehicle 16 at the time the user 12 initiates a reservation is not limiting, as the telematics authentication system 10 confirms from a vehicle availability schedule if the vehicle 16 will be available at the date and time the user 12 requests the use. The vehicle 16 may therefore be parked at the time of reservation, or may be in use with a different user. For autonomously operated vehicles, the telematics authentication system 10 will also identify when the vehicle 16 is currently in operation if the vehicle 16 can be routed to the user 12 to meet the user requested start time of the reservation, or if a different vehicle must be scheduled.

A method for authenticating a vehicle reservation by a user using a telematics authentication system of the present disclosure offers several advantages. These include providing the capability to download data concerning a vehicle reservation from a server to a vehicle before the start date of the reservation, with the vehicle storing the data. The method also provides for a secret key to be generated and submitted by the server via the vehicle to the mobile device of a user, ahead of the reservation date, that allows the user when the reservation start date arrives to open an application on the mobile device which automatically confirms the secret key with the vehicle to authorize the user's access to the vehicle. The amount of data required to be sent from the mobile device to the vehicle is therefore reduced, thereby limiting latency introduced by the secure transfer of the data on the reservation start date.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for authenticating a vehicle reservation by a user using a telematics authentication system, comprising:
wirelessly submitting a vehicle reservation from a mobile device to a remotely located server;
the server creating and forwarding a valid certificate to a vehicle;
returning a secret key from the vehicle to the mobile device of a user;
positioning the mobile device and the vehicle within a predefined wireless connection range to permit confirmation of the secret key with the vehicle; and
opening a telematics authentication system application in the mobile device, the mobile device using the telematics authentication system application using the secret key to authorize operation of the vehicle.

2. The method of claim 1, further including at a predetermined time before a start of the vehicle reservation, in a data transfer step the server forwarding an encrypted reservation certificate to the vehicle.

3. The method of claim 2, further including saving the encrypted reservation certificate in a vehicle telematics module of the vehicle, the encrypted reservation certificate including an intermediate certificate and a user token.

4. The method of claim 3, wherein the vehicle wirelessly transmits the secret key as an encrypted secret key defining in part a reproduction of the intermediate certificate or the user token to the server.

5. The method of claim 4, further including upon receipt of the encrypted secret key, the mobile device decrypts the encrypted secret key and stores a decrypted secret key.

6. The method of claim 5, further including verifying an authenticity of the decrypted secret key in a vehicle computer.

7. The method of claim 3, further including:
forwarding an intermediate certificate serial number from the vehicle telematics module to a computer in the vehicle;
identifying using the computer if the intermediate certificate serial number represents a new certificate serial number, and returning a data request to the vehicle telematics module;
forwarding the intermediate certificate from the vehicle telematics module to the computer; and
the computer authenticating and storing the intermediate certificate.

8. The method of claim 7, further including:
the computer authenticating and storing a user certificate and generating the secret key as an encrypted secret key; and
the computer forwarding the encrypted secret key to the vehicle telematics module.

9. The method of claim 1, wherein the positioning step further includes moving the mobile device toward the vehicle until the predefined wireless connection range is achieved.

10. The method of claim 1, wherein the positioning step further includes autonomously moving the vehicle toward the mobile device until the predefined wireless connection range is achieved.

11. A method for authenticating a vehicle reservation by a user using a telematics authentication system, comprising:
opening a telematics authentication system application in a mobile device;
creating a reservation for a vehicle via the telematics authentication system application;
wirelessly submitting the reservation to a remotely located server and closing the telematics authentication system application;
the server creating and forwarding a valid certificate to the vehicle;
the vehicle sending a secret key to the mobile device; and
reopening the telematics authentication system application in the mobile device and using the secret key to authorize operation of the vehicle.

12. The method of claim 11, wherein the creating step includes selecting the vehicle and identifying a reservation start date.

13. The method of claim 12, wherein the reopening step is performed at a predetermined time on a reservation start date ahead of a user accessing the vehicle.

14. The method of claim 13, further including positioning the mobile device and the vehicle within a predefined wireless connection range to permit sending of the secret key.

15. The method of claim 14, wherein the positioning step further includes one of:
moving the mobile device toward the vehicle until the predefined wireless connection range is achieved; or
if the vehicle is an autonomously operated vehicle autonomously moving the vehicle toward the mobile device until the predefined wireless connection range is achieved.

16. The method of claim 11, further including uploading personalized data by the user at the time of generating the reservation including radio preferences, lighting preferences, seat positions, mirror positions, and climate control settings.

17. The method of claim 11, further including uploading personalized data saved in the server to the vehicle at a time of generating the reservation including radio preferences, lighting preferences, seat positions, mirror positions, and climate control settings.

18. A method for authenticating a vehicle reservation by a user using a telematics authentication system, comprising:
opening a telematics authentication system application in a mobile device;
creating a reservation for a vehicle via the telematics authentication system application including selecting the vehicle from multiple identified vehicles and identifying a reservation start date;
wirelessly submitting the reservation to a remotely located server;
the server creating and downloading a valid certificate for the reservation to the vehicle;
the vehicle sending a secret key to the mobile device after which the telematics authentication system application is closed;
on the reservation start date positioning the mobile device and the vehicle within a predefined wireless connection range and reopening the telematics authentication system application in the mobile device to permit wireless authentication of the secret key.

19. The method of claim 18, further including operating a computer in the vehicle to authenticate the secret key.

20. The method of claim 19, further including following authentication of the secret key the computer sending a response verification successful signal to the mobile device to authorize operation of the vehicle.
